(19) United States
(12) Patent Application Publication
(10) Pub. No.: US 2016/0124472 A1
(43) Pub. Date: May 5, 2016

(54) FIXING ASSEMBLY AND FIXING DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: ZHEN-HUA LIU, Wuhan (CN); XIAO-WEN DUAN, Wuhan (CN); DA-LONG SUN, Wuhan (CN)

(21) Appl. No.: 14/553,192

(22) Filed: Nov. 25, 2014

(30) Foreign Application Priority Data
Nov. 4, 2014 (CN) 201410611422.2

(51) Int. Cl. G06F 1/18; F16M 13/02

(52) U.S. Cl. CPC G06F 1/187; F16M 13/02

(57) ABSTRACT

A fixing device comprises a bracket. The bracket comprises a positioning block. The positioning block comprises a positioning post. The bracket defines an opening and a receiving space. The opening communicates with the receiving space. A storage device extends into the receiving space from the opening. The positioning block is configured to resiliently move back. The positioning post is configured to be received in a fixing hole of the storage device to engage with storage device.

### CROSS-REFERENCE TO RELATED APPLICATIONS

This application claims priority to Chinese Patent Application No. 201410611422.2 filed on Nov. 4, 2014, the contents of which are incorporated by reference herein.

### FIELD

The subject matter herein generally relates to fixing devices with fixing assemblies.

### BACKGROUND

Electronic devices, such as microprocessor based computer systems, typically include fixing devices for fixing one or more storage devices to the computer system. The storage devices extend the capabilities of computer systems by providing dedicated hardware to achieve a variety of tasks.

### BRIEF DESCRIPTION OF THE DRAWINGS

Implementations of the present technology will now be described, by way of example only, with reference to the attached figures.

FIG. 1 is an exploded, isometric view of one embodiment of a fixing assembly.

FIG. 2 is another exploded, isometric view of the fixing assembly of FIG. 1.

FIG. 3 is an assembled, isometric view of the fixing assembly of FIG. 1.

FIG. 4 is another assembled, isometric view of the fixing assembly of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a fixing assembly.

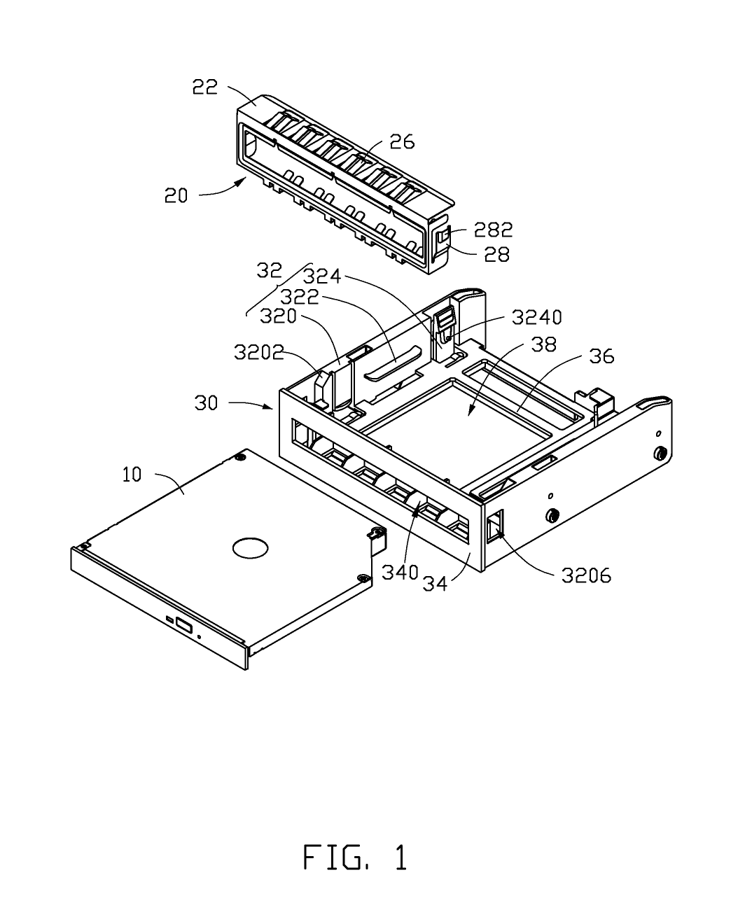

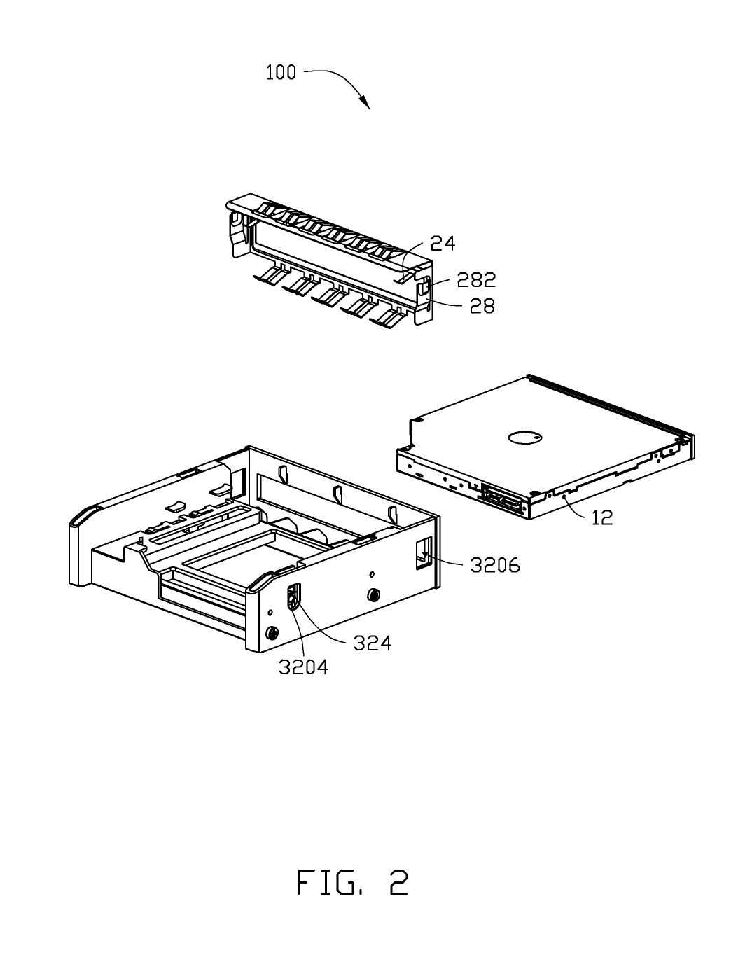

FIGS. 1 and 2 illustrate one embodiment of a fixing assembly 100. The fixing assembly 100 includes storage device 10, a shielding frame 20, and a bracket 30.

The storage device 10 defines a fixing hole 12. The shell of the storage device 10 can be made of metal.

The shielding frame 20 includes a frame 22, at least one first spring clip 24, a plurality of second spring clips 26, and two fixing pieces 28. In at least one embodiment, the frame 22 is substantially rectangular. The at least one first spring clip 24, the plurality of second spring clips 26, and the two fixing pieces 28 extend from the frame 22. The plurality of second spring clips 26 are located on two opposite sides of the frame 22 and align in two opposite rows. The plurality of second spring clips 26 are evenly spaced from each other. The at least one first spring clip 24 is located between the two rows of the second spring clips 26. The two fixing pieces 28 are located on two ends of the frame 22. Each fixing piece 28 includes a protruding portion 282. The shielding frame 20 can be made of electronically conducting material. In at least one embodiment, the shielding frame 20 is made of metal. The shielding frame 20 is substantially rectangular.

The bracket 30 includes two side plates 32, a front plate 34, and a bottom plate 36. The two side plates 32, the front plate 34, and the bottom plate 36 cooperatively define a receiving space 38. The two side plate 32 and the front plate 34 are substantially perpendicular to the bottom plate 36. The two side plates 32 are substantially perpendicular to the front plate 34. Each side plate 32 includes a main portion 320, a plurality of stopper pieces 322, and a positioning block 324. The positioning block 324 includes a positioning post 3240. In at least one embodiment, the positioning post 3240 is substantially cylindrical. The positioning block 324 and the plurality of stopper pieces 322 extend from the main portion 320. The plurality of stopper pieces 322 is substantially parallel to the bottom plate 36. An end of the main portion 320 includes an inclined edge 3202. The inclined edge 3202 is defined near to the plurality of stopper pieces 322. The main portion 320 defines an accommodating hole 3204 and an assembly hole 3206. The accommodating hole 3204 is defined in one side of the positioning block 324. The assembly hole 3206 is defined on one side of the inclined edge 3202. The positioning block 324 is elastically rotatable. The front plate 34 defines an opening 340. The opening 340 communicates with the receiving space 38.

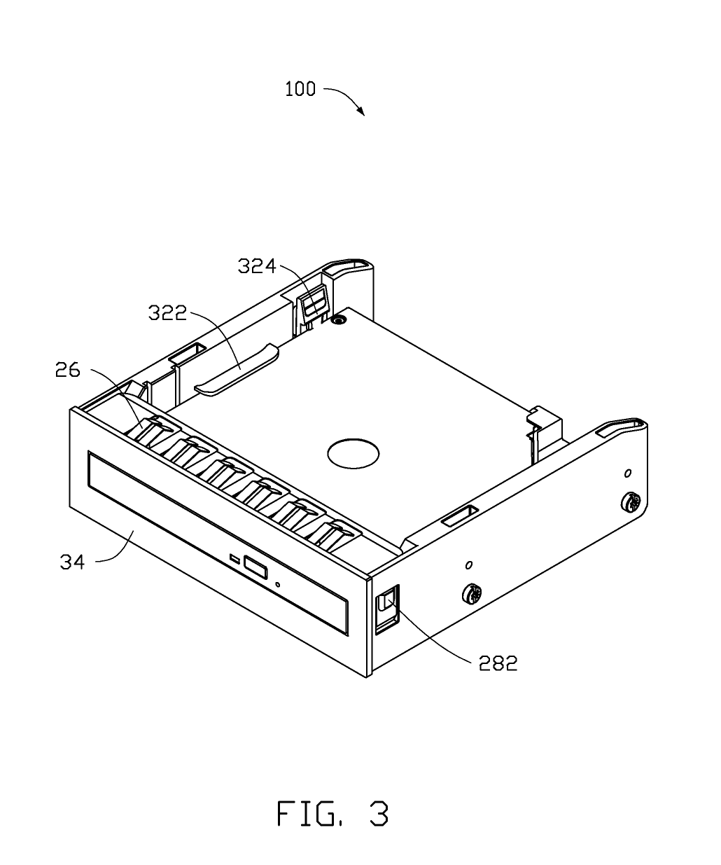

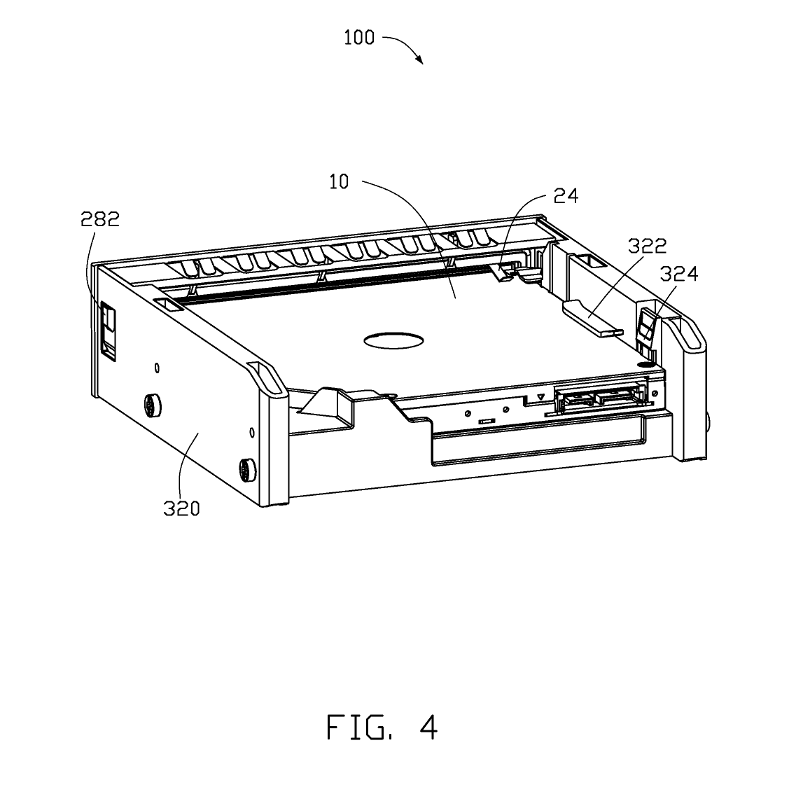

FIGS. 3 and 4 illustrate two views of the assembled fixing assembly 100. In assembly, the shielding frame 20 is engaged with the bracket 30 along the inclined edge 3202 of the two side plates 32. The shielding frame 20 is located on the one end of the bracket 30 and is located near to the front plate 34. The two fixing pieces 28 of the shielding frame 20 are squeezed by the two side plates 32. The protruding portion 282 is received in the assembly hole 3206 and abuts an edge of the assembly hole 3206, providing a force to the positioning block 324. The end of the positioning block 324 is moved to the accommodating hole 3204 until received in the accommodating hole 3204. The storage device 10 extends into the receiving space 38 from the opening 340. The force disappears and the positioning block 324 resiliently moves back to its original position (that is, resiliently deformable). The positioning post 3240 is received in the fixing hole 12 to engage with the storage device 10. The stopper piece 322 abuts the storage device 10 to prevent the storage device 10 from moving relative to the bracket 30. The at least one first spring clip 24 of the shielding frame 20 abuts the storage device 10. The plurality of second spring clips 26 abuts a chassis. The chassis can be made of metal. The electromagnetic waves produced by the storage device 10 can be shielded by the shielding frame 20.

The embodiments shown and described above are only examples. Many details are often found in the art such as the other features of a fixing assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A fixing device for a storage device, comprising:
a bracket comprising a positioning block, the positioning block comprising a positioning post, and the bracket defining an opening and a receiving space;
wherein the opening communicates with the receiving space, when the storage device completely extends into the receiving space from the opening, the positioning block is configured to resiliently move back, and the positioning post is configured to engage with the storage device.

2. The fixing device of claim 1, wherein the bracket further comprises two side plates, each side plate comprises at least one stopper piece, and the at least one stopper piece is used to abut the storage device.

3. The fixing device of claim 2, wherein the bracket further comprises a bottom plate, and the at least one stopper piece is substantially parallel to the bottom plate.

4. The fixing device of claim 2, wherein each side plate defines an accommodating hole, and the positioning block is received in the accommodating hole.

5. The fixing device of claim 1, further comprising a shielding frame, wherein the shielding frame comprises at least one first spring clip, and the at least one first spring clip is used to abut the storage device.

6. The fixing device of claim 5, wherein the shielding frame further comprises a frame and a plurality of second spring clips, the plurality of second spring clips is located on two opposite sides of the frame, and the second spring clips are evenly spaced from each other.

7. The fixing device of claim 5, wherein the bracket further comprises two side plates, the side plate defines an assembly hole, the shielding frame further comprises a fixing piece, the fixing piece comprises a protruding portion, and the protruding portion is received in the assembly hole.

8. The fixing device of claim 5, wherein the bracket is made of a conducting material.

9. The fixing device of claim 8, wherein the bracket is made of metal.

10. A fixing assembly comprising:
a bracket comprising a positioning block, the positioning block comprising a positioning post, and the bracket defining an opening and a receiving space; and
a storage device defining a fixing hole;
wherein the opening communicates with the receiving space, when the storage device completely extends into the receiving space from the opening, the positioning block is configured to resiliently move back, and the positioning post is configured to engage with the fixing hole of the storage device.

11. The fixing assembly of claim 10, wherein the bracket further comprises two side plates, each side plate comprises at least one stopper piece, and the at least one stopper piece abuts the storage device.

12. The fixing assembly of claim 11, wherein the bracket further comprises a bottom plate, and the at least one stopper piece is substantially parallel to the bottom plate.

13. The fixing assembly of claim 11, wherein each side plate defines an accommodating hole, and the positioning block is received in the accommodating hole.

14. The fixing assembly of claim 10, wherein the fixing device further comprises a shielding frame, and the shielding frame comprises at least one first spring clip, and the at least one first spring clip abuts the storage device.

15. The fixing assembly of claim 14, wherein the shielding frame further comprises a frame and a plurality of second spring clips, a plurality of second spring clips is located on two opposite sides of the frame, and the second spring clips are evenly spaced from each other.

16. The fixing assembly of claim 14, wherein the bracket further comprises two side plates, the side plate defines an assembly hole, the shielding frame further comprises a fixing piece, the fixing piece comprises a protruding portion, and the protruding portion is received in the assembly hole.

17. The fixing assembly of claim 14, wherein the bracket is made of a conducting material.

18. The fixing assembly of claim 17, wherein the bracket is made of metal.

19. A fixing device for a storage device comprising:
a bracket defining an opening coupled to a receiving space; and
a positioning block coupled to the bracket and comprising a positioning post,
wherein the positioning block is configured to be resiliently deformable and the positioning post is configured to engage with the storage device.
